(19) United States
(12) Patent Application Publication
(10) Pub. No.: US 2019/0038993 A1
(43) Pub. Date: Feb. 7, 2019

(54) SUB-BOILING DISTILLATION EQUIPMENT

(71) Applicant: Honglin YUAN, Xian (CN)

(72) Inventors: Honglin YUAN, Xian (CN); Kaiyun CHEN, Xian (CN); Tao ZHANG, Xian (CN)

(21) Appl. No.: 15/687,543

(22) Filed: Aug. 28, 2017

(30) Foreign Application Priority Data
Aug. 7, 2017 (CN) 201710665793.2

(51) Int. Cl. B01D 1/00; B01D 3/00; B01D 5/00; C02F 1/04

(52) U.S. Cl. CPC B01D 1/0029; B01D 1/0082; C02F 1/045; B01D 3/00; B01D 5/006; B01D 1/0052

(57) ABSTRACT

The present disclosure discloses a sub-boiling distillation equipment capable of efficiently purifying a raw acid. The sub-boiling distillation equipment is made up of a feeding part, a condensing part, a heating part, a pure acid guiding part, a pure acid receiving part and a tail acid collecting part. The tail acid part is always kept in a normal temperature state, thereby ensuring that tail acid are not simultaneously heated and ensuring purity of distillates. Meanwhile, a controllable PID heating manner is adopted, so as to ensure accuracy of a heating temperature ±0.1° C.

### TECHNICAL FIELD

The present disclosure relates to integrated automatic, efficient and green sub-boiling distillation equipment capable of intelligently purifying nitric acid, hydrochloric acid, hydrofluoric acid, perchloric acid and high purity water. The equipment can be applied to sample dissolution, isotope purification and solution dilution needed in analysis of major and trace elements and isotopes of existing samples of geology, chemistry, materials, environment, archaeology etc., and backgrounds of reagents are guaranteed, thereby improving application researches on accurate analysis of contents of the major and trace elements and isotope compositions such as Sr—Nd—Pb—Li—Mg—Si—Fe—Cu—Mo—U by virtue of inductively coupled plasma mass spectrometry, multi-collector inductively coupled plasma mass spectrometry, high-resolution inductively coupled plasma mass spectrometry, atomic absorption spectroscopy, atomic emission spectroscopy etc. The application researches include uranium-lead dating of zircon in geological samples, the major and trace elements analysis, dissolution of material research samples, and direct and accurate analysis of trace lead isotopes and rare earth elements in minerals (such as feldspar, sulfides, garnet, pyroxene, etc.), environmental samples (such as haze, underground water, soil, etc.) and archaeological samples (such as ancient money, bronze ware, ceramics, skeletons, etc.).

### BACKGROUND

In recent years, a technology for analyzing ultra-low-content trace elements and isotope compositions in samples is rapidly developed along with a further improvement of mass spectrometer performance, thereby realizing a content range from percentage content to 10⁻¹² g/g, quantitative analysis of most of elements from ⁷Li to ²³⁸U and accurate analysis of various metal isotopes, particularly non-traditional stable isotopes developed in recent years. Rapid development of modern mass spectrometry techniques has characteristics of extremely high detection capability, high analysis speed, intelligent sample analysis and data processing, etc. In recent years, the modern mass spectrometry techniques are widely applied in fields such as earth sciences, archaeological science, material science, bioscience, criminal investigation, etc.

However, mass spectrometers only can analyze solution samples or other samples introduced by solid analysis technologies (such as a laser ablation micro-area sampling technology), while common samples researched in geology, material, etc., are generally solid samples, and the solid samples need to be subjected to sample dissolution by a chemical method (including steps of adding the samples into containers such as a sample dissolution bomb, a beaker, etc., destructing crystal structures of the samples with strong acid, such as hydrofluoric acid, concentrated nitric acid, etc., and dissolving powdered solid samples into a solution state), and conveyed into inductively coupled plasma mass spectrometry for performing ionization and ion signal analysis by virtue of an atomizer or carrier gas, thereby obtaining the element content or isotope compositions of the samples.

Key factors for performing overall data quality analysis by a mass spectrometer are the background of strong acids and water. When the samples are dissolved by the chemical method, a sampling amount of the solid samples is often small, and if a content of pollutants in the strong acid is high, mass spectrometer analysis results may be in serious distortion, and true conditions of the samples cannot be accurately reflected. Therefore, purification equipment with high acid purity is necessary. However, acid purification equipment in current market does not have a function of accurately controlling a temperature of a heating zone, causing unstable quality of the purified acid since a temperature may be unstable along with distillation during acid purification (a temperature change range reaches 2-10° C.). Meanwhile, a current acid purification system is not provided with a tail acid collection device, that is, content of impurity elements in residual acids of the same raw acids in a container is higher and higher along with distillation, so that content of impurities in the acid after distillation and purification is slowly increased, thereby influencing quality of the purified acid.

In view of defects of current sub-boiling distillers in China and abroad, the present disclosure discloses a sub-boiling distiller with functions of accurately controlling a temperature and reserving a tail acid, thereby realizing accurate controllability of the temperature during acid and water purification for the first time. The quality of the purified acid can be improved, and reliability and stability of analytical data of inductively coupled plasma mass spectrometers and other modern large-scale analyzing instruments are guaranteed.

### SUMMARY

A purpose of the present disclosure is to overcome function defects of currently common sub-boiling distillers that a heating temperature variation range is wide, a tail acid collection zone does not exist below a heating zone, instrument operations cannot be remotely monitored during an acid purification process, thereby influencing accuracy and efficiency of mass spectrometers and other modern large-scale analyzing instruments during analysis of major and trace elemental contents and isotopic compositions.

For this purpose, the present disclosure provides an intelligent sub-boiling distiller with tail acid storage and accurate temperature control functions. The intelligent sub-boiling distiller comprises a feeding part, a condensing part, a heating part, a pure acid guiding part, a pure acid receiving part and a tail acid collecting part. Sub-boiling distillation equipment in the present application is an integrated closed system. The heating part is composed of a heating zone main body made of a quartz material or PFA/PTFE and a heating jacket coated outside the heating zone main body to heat the heating zone main body; the heating jacket is electrically connected with a control circuit for controlling on-off of the heating jacket; the condensing part is arranged above the heating zone main body and comprises a cooling tower and a condensation cavity; the condensation cavity is a tapered concave structure and is seamlessly connected with the cooling tower; the pure acid guiding part comprises a pure acid receiver provided below the cooling tower, a pure liquid diversion pipe and a final liquid outlet; the pure acid receiving part comprises a pure liquid receiving bottle connected with the final liquid outlet and a receiving bottle top cover; and the tail acid collecting part comprises a tail liquid receiver and heat dissipation holes.

Further, the tail acid collecting part is isolated from the heating part and is always kept at a normal temperature.

Further, the pure acid guiding part and the pure acid receiving part are integrated; and a check valve is arranged on the receiving bottle top cover to discharge air in the bottle, and outside air cannot enter the pure acid receiver, thereby ensuring quality of pure acid.

Further, the control circuit comprises a master controller, a temperature probe for collecting an internal temperature of the heating zone main body, and a solid-state relay. The solid-state relay is electrically connected to the master controller and the heating jacket to control the heating jacket.

Further, a temperature control algorithm is implanted into the master controller and the temperature control algorithm refers to a proportion integration differentiation (PID) control algorithm.

Further, the control circuit further comprises a wireless control module which is in communication connection with the master controller for receiving a control signal transmitted by a user.

The present disclosure has the beneficial effects as follows:

1. With the adoption of a sectioned design, the tail acid part is always kept in a normal temperature state, thereby ensuring that tail acids are not simultaneously heated and ensuring purity of distillates.

2. With the adoption of a controllable PID heating manner, temperature feedback is performed by a PT100 platinum thermistor, and accuracy of a heating temperature ±0.1° C. can be guaranteed.

3. With the adoption of a fully sealed design, net acid is collected by a PFA plastic bottle, the air in the bottle is discharged by the check valve, and the outside air cannot enter the PFA bottle and pollute the net acid.

4. With the adoption of an internet technology, an operating state of the sub-boiling distiller can be observed by a remote computer or mobile phone app, thereby controlling the operation of the heater.

### BRIEF DESCRIPTION OF DRAWINGS

The present disclosure is further described below in detail in combination with drawings and specific embodiments.

FIG. 1 is a schematic diagram of a major structure of each part of a sub-boiling distiller in the present disclosure.

FIG. 2 is a schematic diagram of a specific structure of each part of a sub-boiling distiller in the present disclosure.

FIG. 3 is a schematic diagram of a heating control system of a sub-boiling distiller.

Description of drawing marks: 1, sub-boiling distiller; 11, feeding part; 111, feeding hole; 112, feeding hopper; 113, feeding top cover; 12, condensing part; 13, heating part; 14, pure acid guiding part; 15, pure acid receiving part; 16, tail acid collecting part; 17, fixing rack; 18, fixing rack top cover; 19, base; 20, bottle mat; 121, cooling tower; 122, condensation cavity; 131, heating zone main body; 132, heating jacket; 141, pure acid receiver; 142, pure liquid diversion pipe; 143, final liquid outlet; 151, pure liquid receiving bottle; 152, receiving bottle top cover; 153, check valve; 161, tail liquid receiver; 162, heat dissipation hole; 3, control circuit; 30, master controller; 31, temperature probe; 32, solid-state relay; 33, user key input circuit; and 34, wireless control module.

### DETAILED DESCRIPTION

The present disclosure is further described below in combination with drawings and embodiments:

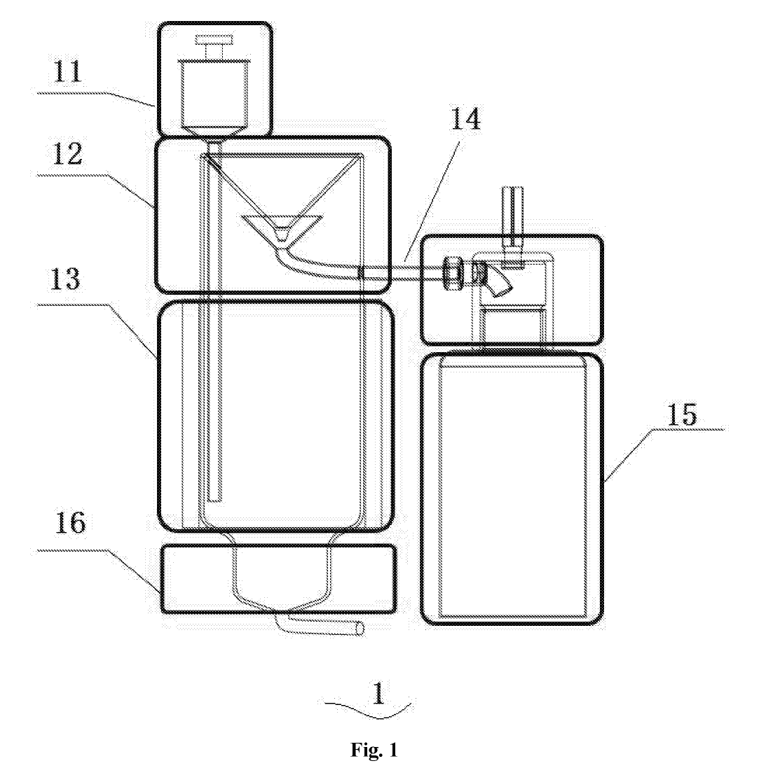

The present embodiment provides an intelligent sub-boiling distiller which can accurately control a temperature and has a tail acid collection function. In combination with FIG. 1, the sub-boiling distiller 1 comprises a feeding part 11, a condensing part 12, a heating part 13, a pure acid guiding part 14, a pure acid receiving part 15 and a tail acid collecting part 16. A raw acid enters the heating part 13 through the feeding part 11 and is heated. A gaseous pure acid obtained by distillation is condensed by the condensing part 12, and enters the pure acid receiving part 15 through the pure acid guiding part 14 and is collected. The residual raw acid with high content of impurities after distillation is collected by the tail acid collecting part 16 and then discharged. The tail acid collecting part 16 is provided on the lowest part and isolated from the heating part 13. The tail acid collecting part 16 is kept at a normal temperature to avoid reducing quality of purified acid because a tail acid with high content of impurities is heated. A tail acid outlet is provided at the lowest end for discharging all acid in the heating part 13 without any residue.

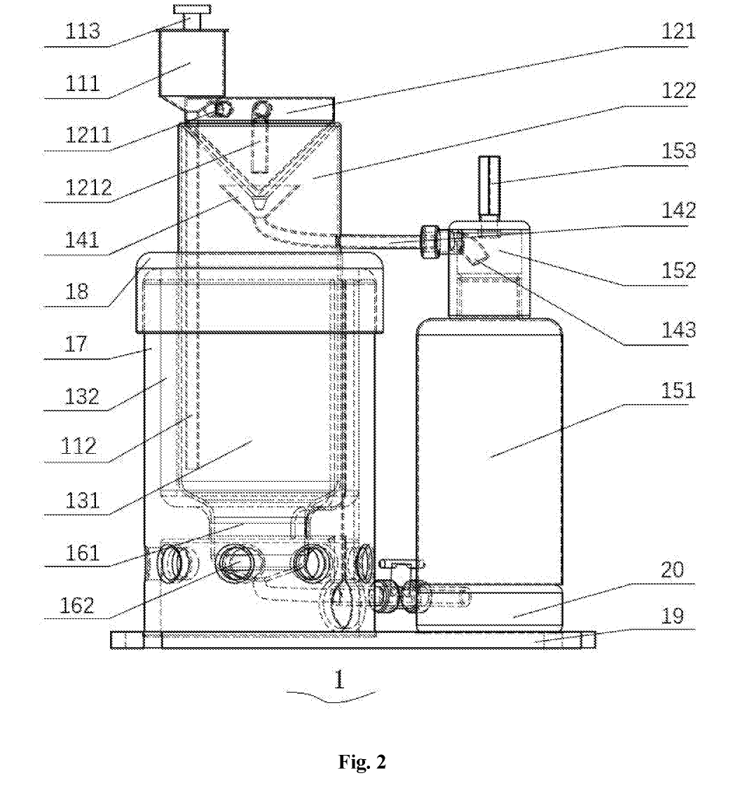

By referring to FIG. 2, FIG. 2 illustrates a specific structure of each part of a sub-boiling distiller in embodiment 1. The feeding part 11 comprises a feeding hole 111, a feeding hopper 112 and a feeding top cover 113. A raw acid enters the heating part 13 through the feeding hole 111 via the feeding hopper 112. The feeding top cover 113 is used for sealing the feeding hole.

The heating part 13 is composed of a heating zone main body 131 made of a quartz material or other materials such as PFA, PTFE etc., and a heating jacket 132 coated outside the heating zone main body 131 to heat the heating zone main body 131. In a certain implementation, the heating jacket 132 is a silica gel heating piece electrically connected with an outside heating control device. In another implementation, the heating jacket 132 is a silica gel coated heating piece with a thermal insulation layer.

The condensing part 12 is arranged above the heating zone main body 131 and comprises a cooling tower 121 and a condensation cavity 122. The condensation cavity 122 is a tapered concave structure and is seamlessly connected with the cooling tower 121. The cooling tower 121 further comprises a cooling water inlet 1211 and a cooling water outlet 1212. External circulating water enters the cooling tower 121 through the cooling water inlet 1211 along a tangential direction to take away heat and is discharged from the cooling water outlet 1212.

The condensed pure acid enters the pure acid receiving part 15 through the pure acid guiding part 14 and is collected, wherein the pure acid guiding part 14 comprises a pure acid receiver 141 provided below the cooling tower 121, a pure liquid diversion pipe 142 and a final liquid outlet 143. The final liquid outlet 143 extends into the pure acid receiving part 15.

The pure acid receiving part 15 comprises a pure liquid receiving bottle 151 connected with the pure liquid guide pipe 142, and a receiving bottle top cover 152. A check valve 153 is arranged on the receiving bottle top cover 152. At an initial stage of distillation, air in the bottle is discharged through the check valve 153, so that outside air cannot enter into the pure liquid receiving bottle 151 to pollute net acid. The pure liquid receiving bottle 151 is a bottle body made of PFA plastics (soluble polytetrafluoroethylene). The pure liquid receiving bottle 151 is sealed by the receiving bottle top cover 152 and the check valve 153.

The tail acid collecting part 16 is arranged below the heating zone main body 131 and comprises a tail liquid receiver 161 and heat dissipation holes 162. The tail acid collecting part 16 is independently arranged below the heating zone main body 131, is good in ventilation and is always kept at a normal temperature. Therefore, residual impurities after acid purification are collected herein. Because heating is not performed, high-quality acid can be always heated in the upper heating zone main body 131, thereby guaranteeing that the pure acid receiving part 15 collects high-purity acid and has low backgrounds. In the present embodiment, a fully closed design is adopted. In another implementation, the sub-boiling distiller 1 further comprises a fixing rack 17 used for fixing the heating part 13 and a fixing rack top cover 18. The fixing rack 17 and the fixing rack top cover 18 are provided above a base 19. The pure liquid receiving bottle 151 is arranged above a bottle mat 20.

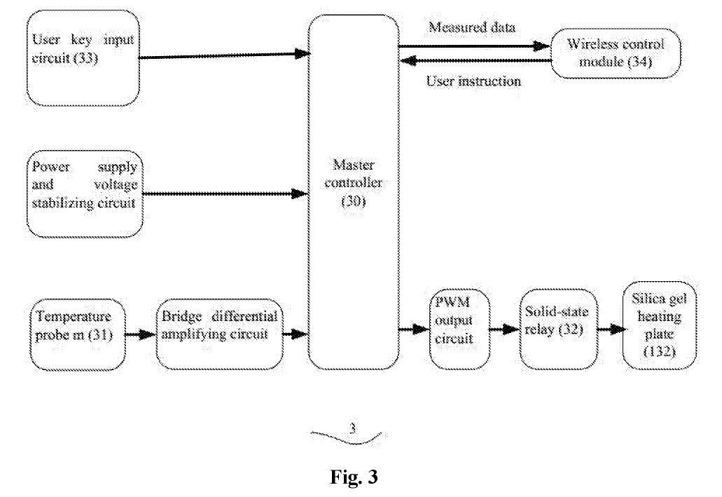

By referring to FIG. 3, FIG. 3 illustrates a control circuit 3 for controlling the heating of the heating part 13. The control circuit 3 is composed of a master controller 30, a temperature probe 31 for collecting an internal temperature of the heating zone main body 131, and a solid-state relay 32.

The master controller 30 is an STM32 embedded device. The temperature probe 31 is a PT100 platinum thermistor. The heating jacket 13 is electrically connected to the solid-state relay 32. The master controller 30 controls the heating jacket 13 by controlling on-off of the solid-state relay.

A temperature control algorithm is implanted into the master controller 30 and refers to a proportion integration differentiation (PID) control algorithm, so that the temperature control accuracy can reach ±0.1° C.

In a certain implementation, a user can interact with the master controller 30 through the key input circuit 33, thereby realizing temperature setting and other functional operations.

Certainly, in another implementation, user instructions in the present application, such as a temperature setting signal and an on-off signal, can be issued by a wireless control module 34. The wireless control module 34 is in communication connection with the master controller 30 and is used for interacting with the user and receiving a control signal transmitted by the user. In a certain implementation, a WIFI module takes ESP8266WIFI as a core and can realize a remote temperature monitoring function remotely by a microcomputer or a mobile terminal (such as a smartphone) through wireless data transmission in combination with a self-programmed application program, thereby monitoring a heating temperature, heating time and the like of the heating zone main body 131 by a remote computer terminal or an intelligent terminal.

In conclusion, the intelligent sub-boiling distiller capable of always maintaining acid purification quality in the present disclosure can ensure a blank background problem caused by acid used in sample dissolution in existing trace element and isotope analysis, which has important significances in research and application of analysis of the content of ultra-low-content trace elements and isotope compositions with respect to an increasingly stronger existing mass spectrometry technical function and improvement of detection capability. Therefore, the quantity of the samples can be further reduced, and usage of acid dissolved sample is reduced, thereby reducing damage of usage of the acid to the environment.

It should be understood that those ordinary skilled in the art can make improvements or transformations according to description above, while all the improvements and transformations should belong to a protection scope of appended claims in the present disclosure.

The patent of the present disclosure is illustratively described above in combination with drawings. Apparently, implementation of the patent of the present disclosure is not limited by the manners above. All improvements performed using method concepts and technical solutions of the patent of the present disclosure or direct applications of concepts and technical solutions of the patent of the present disclosure in other occasions without improvements are included in the protection scope of the present disclosure.

What is claimed is:

1. A sub-boiling distillation equipment for purifying raw acid, comprising:
a feeding part (11), a condensing part (12), a heating part (13), a pure acid guiding part (14), a pure acid receiving part (15) and a tail acid collecting part (16);
wherein the sub-boiling distillation equipment is an integrated closed system;
the heating part (13) is composed of a heating zone main body (131) made of a quartz material and/or PFA/PTFE, and a heating jacket (132) coated outside the heating zone main body (131) to heat the heating zone main body (3); the heating jacket (132) is electrically connected with a control circuit (3) for controlling on-off of the heating jacket (132);
the condensing part (12) is arranged above the heating zone main body (131) and comprises a cooling tower (121) and a condensation cavity (122); the condensation cavity (122) is a tapered concave structure, and is seamlessly connected with the cooling tower (121);
the pure acid guiding part (14) comprises a pure acid receiver (141) provided below the cooling tower (121), a pure liquid diversion pipe (142) and a final liquid outlet (143);
the pure acid receiving part (15) comprises a pure liquid receiving bottle (151) connected with the final liquid outlet (143), and a receiving bottle top cover (152); and
the tail acid collecting part (16) comprises a tail liquid receiver (161) and heat dissipation holes (162).

2. The sub-boiling distillation equipment according to claim 1, wherein the tail acid collecting part (16) is isolated from the heating part (13) and is kept at a normal temperature.

3. The sub-boiling distillation equipment according to claim 1, wherein the pure acid guiding part (14) and the pure acid receiving part (15) are integrated; and a check valve (153) is arranged on the receiving bottle top cover (152) to discharge air in the bottle, and outside air cannot enter the pure acid receiver (141), ensuring quality of pure acid.

4. The sub-boiling distillation equipment according to claim 1, wherein the control circuit (3) comprises a master controller (30), a temperature probe (31) for collecting an internal temperature of the heating zone main body (131), and a solid-state relay (32); and the solid-state relay (32) is electrically connected to the master controller (30) and the heating jacket (132) to control the heating jacket (132).

5. The sub-boiling distillation equipment according to claim 4, wherein a temperature control algorithm is implanted into the master controller (30) and the temperature control algorithm is a proportion integration differentiation (PID) control algorithm.

6. The sub-boiling distillation equipment according to claim 4, wherein the control circuit (3) further comprises a wireless control module (34) which is in communication connection with the master controller (30) for receiving a control signal transmitted by a user.
